(19) United States
(12) Patent Application Publication
(10) Pub. No.: US 2023/0206192 A1
(43) Pub. Date: Jun. 29, 2023

(54) METHOD AND SYSTEM OF PROVIDING PROOF OF PROVENANCE OF DIGITAL RECEIPT

(71) Applicant: MASTERCARD INTERNATIONAL INCORPORATED, Purchase, NY (US)

(72) Inventor: Rahul DESHPANDE, Chesterfield, MO (US)

(73) Assignee: MASTERCARD INTERNATIONAL INCORPORATED, Purchase, NY (US)

(21) Appl. No.: 17/563,221

(22) Filed: Dec. 28, 2021

(51) Int. Cl. G06Q 20/04; G06Q 20/06; G06Q 20/38

(52) U.S. Cl. CPC G06Q 20/047; G06Q 20/065; G06Q 20/389; G06Q 20/38215; G06Q 20/3825

(57) ABSTRACT

A method for generating a digital receipt for a transaction including provenance information for purchased products includes: receiving a data request from a first computing device including a transaction identifier related to a processed payment transaction; identifying transaction details for the processed payment transaction based on the transaction identifier, the transaction details including a product identifier for each of one or more products purchased in the processed payment transaction; transmitting the product identifier for each of the one or more products to a second computing device; receiving provenance data for each of the one or more products from the second computing device; generating a digital receipt for the processed payment transaction, the digital receipt including the received provenance data for each of the one or more products; and transmitting the generated digital receipt to the first computing device.

### FIELD

The present disclosure relates to providing proof of provenance of a product via a digital receipt, specifically the generation of a digital receipt for a transaction that includes provenance information for purchased products.

### BACKGROUND

In recent years more than ever, consumers are interested in where the products that they purchase and interact with come from. There are a myriad of reasons someone can be interested in the provenance of a product: a consumer can want to ensure the manufacturer uses ethical practices, a reseller can want to confirm the ownership history of a secondhand item, a manufacturer can need to track the distribution of products related to a necessary recall, a distributor can have concerns about leakage during the distribution process of a particular product, etc. Traditionally, solutions for these problems can vary as much as the problems themselves. For instance, a distributor can use a scanning system and place its own labels on packages, but this can be of little-to-no use to the manufacturer or end user. In another example, a consumer can discover the ethical practices of a manufacturer but be unable to verify if a product they are purchasing is genuine from the manufacturer. In yet another example, a manufacturer can need a recall and know which products must be recalled but have little capability of contacting the end merchants or consumers that received the products.

One such solution is the use of a blockchain to track the provenance of an item through the supply chain. Such a solution is described in U.S. patent application Ser. No. 16/875,154, entitled “Method and System for Generalized Provenance Solution for Blockchain Supply Chain Applications,” filed on Can 15, 2020, by Steven C. Davis et al., which is herein incorporated by reference in its entirety. In that solution, a new entry on a blockchain is created for every event that affects the provenance of a product, such as its manufacturer, each time it passes from one distributor to another, and its sale to a consumer. Because the blockchain is immutable, the information cannot be changed, and thus there is an accurate record of the provenance of the product that is highly resistant to fraud.

However, blockchains are often not consumer-friendly. A consumer that purchases a product can be unaware that such a record of the provenance of the product exists. Even if aware, the consumer must be able to find out how to access the blockchain, identify the appropriate unique identifier for the purchased product, identify the related entries on the blockchain, and analyze the identified entries to obtain the information regarding the provenance of the product. Such steps can be difficult for consumers that are not technologically savvy and can be time consuming for those that are. As a result, there is a need for a technological solution to simplify the process of identifying the provenance of a product and presenting it to a consumer.

### SUMMARY

The present disclosure provides a description of systems and methods for generating a digital receipt for a transaction including provenance information for purchased products. A consumer can, using a suitable computing device, request information about a transaction they were involved in, such as when accessing their banking information or a credit card statement through a dedicated website or application program. Such a request for information can be sent to a processing server that is configured to identify a unique identifier for each of the products purchased in the transaction and obtain provenance information for each product, either through a separate computing device or directly by the processing server. The provenance information can be used to generate provenance data for each of the purchased products, such as can be formatted in a manner suitable for digestion by the requesting consumer. A digital receipt can be generated for the transaction that includes the generated provenance data, which is then transmitted to the consumer's device for presentation thereto. The result is easily accessible provenance information for purchased products using an interface through which the consumer is already familiar.

A method for generating a digital receipt for a transaction including provenance information for purchased products includes: receiving, by a receiver of a processing server, a data request from a first computing device including at least a transaction identifier related to a processed payment transaction; identifying, by a processor of the processing server, transaction details for the processed payment transaction based on the transaction identifier, the transaction details including at least a product identifier for each of one or more products purchased in the processed payment transaction; transmitting, by a transmitter of the processing server, the product identifier for each of the one or more products to a second computing device; receiving, by the receiver of the processing server, provenance data for each of the one or more products from the second computing device; generating, by the processor of the processing server, a digital receipt for the processed payment transaction, the digital receipt including at least the received provenance data for each of the one or more products; and transmitting, by the transmitter of the processing server, the generated digital receipt to the first computing device.

A system for generating a digital receipt for a transaction including provenance information for purchased products includes: a first computing device; a second computing device; and a processing server including a receiver receiving a data request from the first computing device including at least a transaction identifier related to a processed payment transaction, a processor identifying transaction details for the processed payment transaction based on the transaction identifier, the transaction details including at least a product identifier for each of one or more products purchased in the processed payment transaction, and a transmitter transmitting the product identifier for each of the one or more products to a second computing device, wherein the receiver of the processing server further receives provenance data for each of the one or more products from the second computing device, the processor of the processing server further generates a digital receipt for the processed payment transaction, the digital receipt including at least the received provenance data for each of the one or more products, and the transmitter of the processing server further transmits the generated digital receipt to the first computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for generating a digital receipt with provenance information in accordance with exemplary embodiments.

FIG. 2 is a block diagram illustrating the processing server in the system of FIG. 1 for generating a digital receipt with provenance information in accordance with exemplary embodiments.

FIGS. 3A and 3B are a flow diagram illustrating a process for generating a digital receipt with provenance information in the system of FIG. 1 in accordance with exemplary embodiments.

FIG. 4 is a flow chart illustrating an exemplary method for generating a digital receipt for a transaction including provenance information for purchased products in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Generating a Digital Receipt with Proof of Provenance

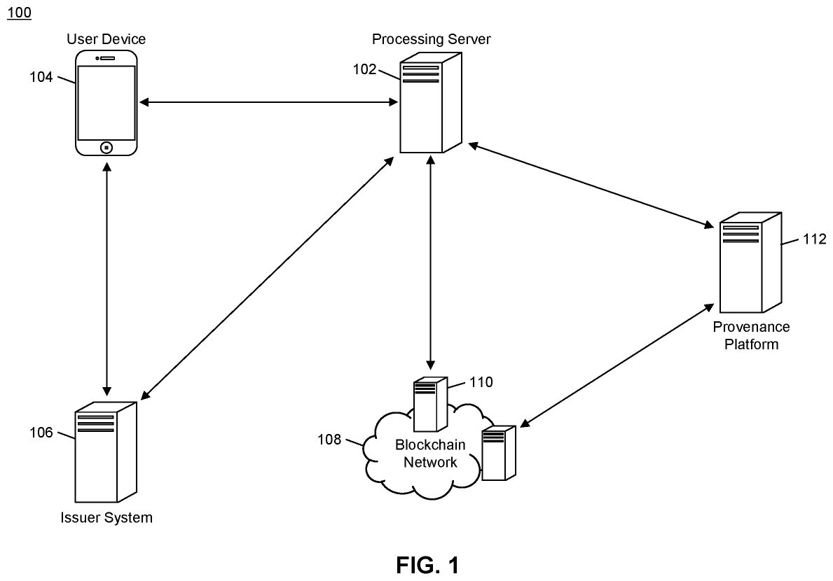

FIG. 1 illustrates a system 100 for generating a digital receipt that includes proof of provenance information for products purchased in a payment transaction.

The system 100 can include a processing server 102. The processing server 102, discussed in more detail below, can be configured to generate digital receipts for payment transactions that include provenance information for a purchased product for use by a consumer. In the system 100, a consumer can utilize a user device 104 to request a digital receipt from the processing server 102. The user device 104 can be any type of computing device suitable of being specifically programmed for performing the functions discussed herein, such as a desktop computer, laptop computer, tablet computer, notebook computer, cellular phone, smart phone, smart watch, smart television, wearable computing device, etc. The consumer can interact with the user device 104 to access a list of payment transactions, such as payment transactions the consumer was involved with, and select a payment transaction for which a digital receipt is requested. The user device 104 can electronically transmit a unique identifier for the payment transaction, referred to herein as a transaction identifier, to the processing server 102 using a suitable communication network and method.

In some embodiments, the user device 104 can access a website that displays a list of payment transactions for which a digital receipt can be made available, such as can be hosted by or on behalf of the processing server 102. In such an embodiment, the transaction identifier for the selected transaction can be submitted to the processing server 102 via a form in the webpage or a hyperlink. In other embodiments, the user device 104 can have an application program stored thereon or otherwise accessible thereby and executed by the user device 104 that displays the list of payment transactions. In such an embodiment, the transaction identifier for the payment transaction can be electronically transmitted to the processing server 102 via an application programming interface or other suitable method.

The processing server 102 can receive the transaction identifier from the user device 104 and identify transaction details for the payment transaction that is associated with the transaction identifier. Transaction details can include any data associated with the payment transaction that includes at least a unique identifier, referred to herein as a product identifier, for each product purchased in the payment transaction. Additional transaction details can include, for instance, time, date, geographic location, transaction type, currency, payment method, merchant identifier, point of sale identifier, user device identifier, reward data, loyalty data, coupon data, transaction amount, sale data, tax data, other product data for each purchased product, etc. In some embodiments, transaction details for payment transactions can be stored in a database local to or otherwise accessible by the processing server 102. In such an embodiment, the processing server 102 can query the database using the transaction identifier to identify the transaction details for the associated payment transaction.

In other embodiments, the processing server 102 can be configured to obtain the transaction details from another computing system. For instance, the system 100 can include an issuer system 106, which can be a computing system of or associated with an issuing financial institution, such as an issuing bank, that issued a transaction account that was used to fund the payment transaction for which a digital receipt is requested. The issuer system 106 can locally store or otherwise have access to transaction details for the selected payment transaction. The processing server 102 can electronically transmit the transaction identifier to the issuer system 106 using a suitable communication network and method. The issuer system 106 can, using the transaction identifier, identify the additional transaction details for the payment transaction, and electronically transmit the additional transaction details back to the processing server 102 in a data message using a suitable communication network and method.

In some embodiments, the processing server 102 and the issuer system 106 can be part of the same computing system or environment, or, in some cases, can be the same device configured to perform the functions of both the processing server 102 and issuer system 106 as discussed herein. For example, the user device 104 can execute an application program associated with the issuing financial institution (e.g., a banking app) to view a list of payment transactions and select a payment transaction for which a digital receipt is requested. In such an example, the issuer system 106 can receive the transaction identifier via the application program and identify the additional transaction details for the associated payment transaction. In one embodiment, in a case where the processing server 102 is separate from the issuer system 106, the issuer system 106 can receive the transaction identifier via the banking application, identify the additional transaction details, and can electronically transmit the transaction details to the processing server 102 for use in identifying provenance data and generating the digital receipt.

Once the processing server 102 has identified the additional transaction details for a payment transaction, including at least a product identifier for each product purchased in the payment transaction, the processing server 102 can identify provenance data for each of the purchased products. In some embodiments, the processing server 102 can first electronically transmit a list of purchased products to the user device 104 for display to a user thereof, where the user can select one or more of the purchased products for which provenance data is requested. In such embodiments, the user device 104 can electronically transmit the user selection (e.g., the product identifier for each selected product) to the processing server 102. In such cases, the processing server 102 can identify provenance data only for products that were selected by the user of the user device 104.

The processing server 102 can be configured to identify the provenance data for each product directly or can receive the provenance data for each product from a separate computing system, such as a provenance platform 112. Accordingly, the functions discussed herein regarding the identification of provenance data can be performed by the processing server 102 and/or the provenance platform 112 where the processing server 102 and provenance platform can communicate with one another using any suitable communication network and method.

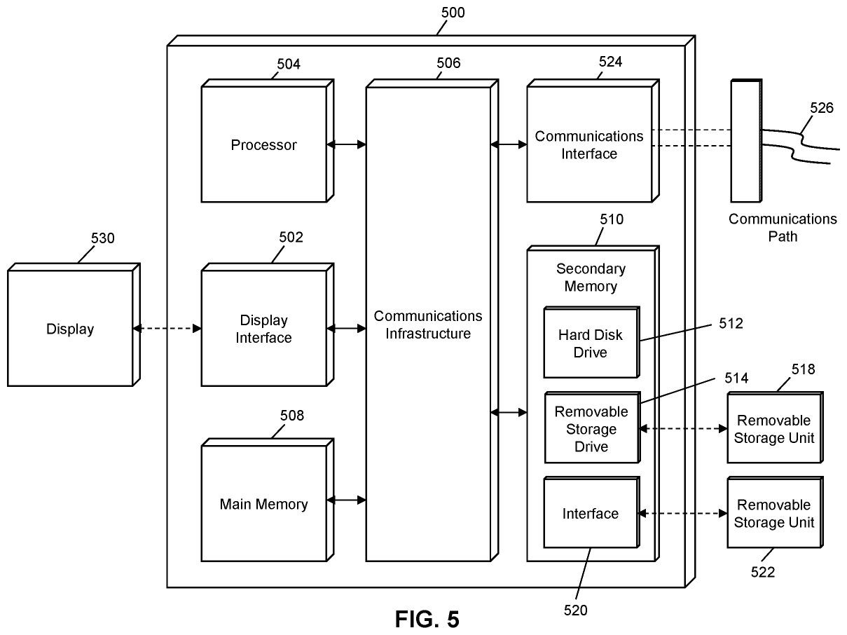

The processing server 102 can be configured to obtain data regarding the provenance of each product from a blockchain. The blockchain can be created and maintained by a blockchain network 108. The blockchain network 108 can be comprised of a plurality of blockchain nodes 110. Each blockchain node 110 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 can be a blockchain node 110 in the blockchain network 108. In such embodiments, all functions of blockchain nodes 112 discussed herein can be performed by the processing server 102.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 110 in the blockchain network 108 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 108 using the public key of the cryptographic key pair. In some cases, the term “blockchain wallet” can refer specifically to the private key. In other cases, the term “blockchain wallet” can refer to a computing device (e.g., a user device 104, processing server 102, issuer system 106, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., the user device 104) that is generated using the sender's private key, a blockchain address of the recipient of currency (e.g., another user device 104) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 110 in the blockchain network 108, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other nodes in the blockchain network 108 before being added to the blockchain and distributed to all of the blockchain nodes 110 in the blockchain network 108, respectively, in traditional blockchain implementations. In cases where a blockchain data value cannot be related to a blockchain transaction, but instead the storage of other types of data, blockchain data values can still include or otherwise involve the validation of a digital signature.

In the system 100, blockchain data values can be used to store data regarding events associated with the provenance of a product. Additional information regarding the storage of provenance data in blockchain data values can be found in, e.g., U.S. patent application Ser. No. 16/875,154, entitled “Method and System for Generalized Provenance Solution for Blockchain Supply Chain Applications,” filed on Can 15, 2020, by Steven C. Davis et al., which is herein incorporated by reference in its entirety. Such event information for the provenance of a product can include, for example, data regarding the manufacture, distribution, shipping, stocking, sale, and resale of a product. For instance, a blockchain data value can include an event for the date of manufacture that is digitally signed by the manufacturer, an event for the date when the product is picked up from the manufacturer for distribution and signed by the distributor, an event for the date when the product is picked up by a last-mile shipping agent and signed by the agent, an event for the date when the product is delivered to a merchant for sale and signed by the merchant, an event for the date when the product is made available for purchase and signed by the merchant, an event for the date when the product is purchased and signed by the purchasing consumer, etc.

Each blockchain data value can include the product identifier for the product with which the provenance event is associated. The product identifier can be any value that is unique to the product among all other products for which provenance data is stored in the blockchain. The product identifier can be, for example, an assigned identification value, a registration number, a serial number, a universal product code, or other suitable value. The processing server 102 can identify every blockchain data value in the blockchain that includes the product identifier for each product whose provenance data is to be identified. The processing server 102 can analyze each of the identified blockchain data values to generate a set of provenance data for the product.

The set of provenance data can depend on the number and type of blockchain data entries that are identified and analyzed for a product, which can vary depending on the product and its history. For example, some goods can have detailed manufacturing history available, such as for the sourcing of one or more of the materials that were used in the manufacture of the product, while other goods can only have a manufacturing date and/or location. The processing server 102 can also be configured to enrich the provenance data for an object, such as by identifying names of entities involved in an event (e.g., using identifying information included in the respective blockchain data entry) or formatting data for readability by a user of the user device 104 (e.g., converting timestamps into a recognizable time and date format, converting geographical coordinates into a city and state or street address, etc.).

Once the provenance data for each of the products has been generated by the processing server 102, the processing server 102 can generate a digital receipt for the payment transaction. The digital receipt can be a data object that includes the set of provenance data for each of the selected products purchased in the payment transaction as well as any of the additional transaction details obtained by the processing server 102. In some cases, the digital receipt can be formatted in a manner similar to traditional, physical receipts for easier readability by the consumer. The data object can be any type of data object suitable for the transmission and presentation of the digital receipt, such as an image file that displays the digital receipt, a text file that includes all of the data formatted for readability, or other data file that can be opened and viewed by the consumer using the user device 104. Once the digital receipt has been generated, the processing server 102 can electronically transmit the digital receipt to the user device 104 using a suitable communication network and method. The user device 104 can then display the digital receipt to the user thereof. For instance, in an example where the digital receipt was requested via a webpage, submission of the transaction identifier can display a new page that includes the digital receipt generated by the processing server 102. In another example, in cases where the user device 104 executes an application program for selection of the transaction identifier, the application program can display the digital receipt in response. The processing server 102 and/or user device 104 can store generated and/or received digital receipts for display or transmission later on if requested again by the user.

In some embodiments, the provenance data included in the digital receipt can include hyperlinks or other interactable elements. Using such elements, the user can be able to request additional detail regarding the provenance of a product or a particular provenance event. For example, the provenance data for a luxury good can display “Manufactured on Aug. 1, 2021 by LuxuryCo” on the digital receipt. The user can interact with the text or using another suitable element to view additional information. In such a case, the user device 104 can electronically transmit a request to the processing server 102 for additional information that can include the text, transaction identifier, product identifier, event identifier (e.g., embedded in the digital receipt as identified in the corresponding blockchain data entry), or other suitable information. The processing server 102 can, using the information, identify the blockchain data entry corresponding to the event and identify additional details that are formatted and transmitted back to the user device 104 in a data message. The user device 104 can then display the additional details, such as part of the digital receipt or in a separate display element. For instance, in the above example, the user can be presented with an exact time of manufacture, a geographic location where the good was manufactured, the digital signature of LuxuryCo, and a result of a verification of that digital signature using a public key of LuxuryCo's cryptographic key pair.

The methods and systems discussed herein enable a consumer to view a digital receipt for a past payment transaction that includes provenance data for products purchased as part of the payment transaction. The use of the processing server 102 to identify the transaction details and then to identify the provenance data and then generate the digital receipt including the provenance data enables the consumer to obtain this useful information without modification to issuer systems 106 or user devices 104 and can be done so in a manner with which the consumer is already comfortable. As such, the processing server 102 can provide for an improvement to existing systems through which consumers view their transaction history and can present provenance data to a consumer in a user-friendly manner that is unavailable in existing systems.

### Processing Server

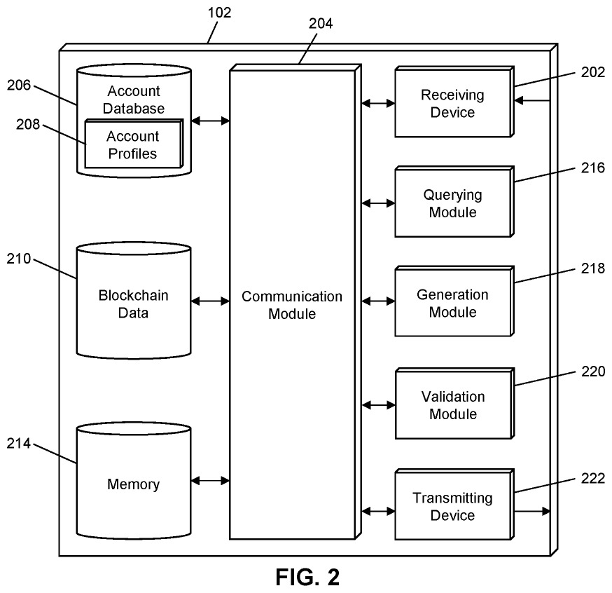

FIG. 2 illustrates an embodiment of the processing server 102 in the system 100. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. Additional components in the system 100, such as user device 104, blockchain node 110, and provenance platform 112 can include components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from user devices 104, issuer systems 106, blockchain nodes 110, provenance platforms 112, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by user devices 104 that are superimposed or otherwise encoded with transaction identifiers and other data for use in requesting a digital receipt, such as a product identifier for one or more products, provenance data for which more detail is requested, specific requests regarding provenance data, etc. The receiving device 202 can also be configured to receive data signals electronically transmitted by issuer systems 106 that are superimposed or otherwise encoded with transaction details, transaction identifiers, transaction account data, etc. The receiving device 202 can be further configured to receive data signals electronically transmitted by blockchain nodes 110 and/or provenance platforms, which can be superimposed or otherwise encoded with blocks, blockchain data entries, provenance data, provenance events, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can include an account database 206. The account database 206 can be configured to store a plurality of account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to one or more consumers and/or associated user devices 104. For example, an account profile 208 can include transaction details for a plurality of payment transactions involving the associated consumer, which can be stored in the account profile 208 using the transaction identifier for the respective payment transaction for identification during the methods discussed herein.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, communication information, data formatting rules, blockchain data, signature generation algorithms, account information, provenance data formatting rules, etc.

The processing server 102 can include a querying module 216. The querying module 216 can be configured to execute queries on databases to identify information. The querying module 216 can receive one or more data values or query strings, and can execute a query string based thereon on an indicated database, such as the memory 212 of the processing server 102 to identify information stored therein. The querying module 216 can then output the identified information to an appropriate engine or module of the processing server 102 as necessary. The querying module 216 can, for example, execute a query on the account database 206 to identify an account profile 208 for a consumer requesting a digital receipt for a payment transaction and to identify transaction details for the transaction stored therein using a transaction identifier.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate notification messages, confirmation messages, digital signatures, machine readable codes, transaction amounts, data objects, digital receipts, sets of provenance data, etc.

The processing server 102 can also include a validation module 220. The validation module 220 can be configured to perform validations for the processing server 102 as part of the functions discussed herein. The validation module 220 can receive instructions as input, which can also include data to be used in performing a validation, can perform a validation as requested, and can output a result of the validation to another module or engine of the processing server 102. The validation module 220 can, for example, be configured to validate digital signatures using suitable signature generation algorithms and keys, validate data objects and/or data included therein, etc.

The processing server 102 can also include a transmitting device 222. The transmitting device 222 can be configured to transmit data over one or more networks via one or more network protocols. In some instances, the transmitting device 222 can be configured to transmit data to user devices 104, issuer systems 106, blockchain nodes 110, provenance platforms 112, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to user devices 104 that are superimposed or otherwise encoded with data objects, digital receipts, sets of provenance data, detailed provenance data, blockchain data entries, authentication requests, lists of payment transaction identifiers, etc. The transmitting device 222 can also be configured to electronically transmit data signals to issuer systems 106 that are superimposed or otherwise encoded with transaction identifiers. The transmitting device 222 can be further configured to electronically transmit data signals to blockchain nodes 110 and/or provenance platforms, which can be superimposed or otherwise encoded with product identifiers, blockchain data entries identifiers, etc.

### Process for Generating a Digital Receipt

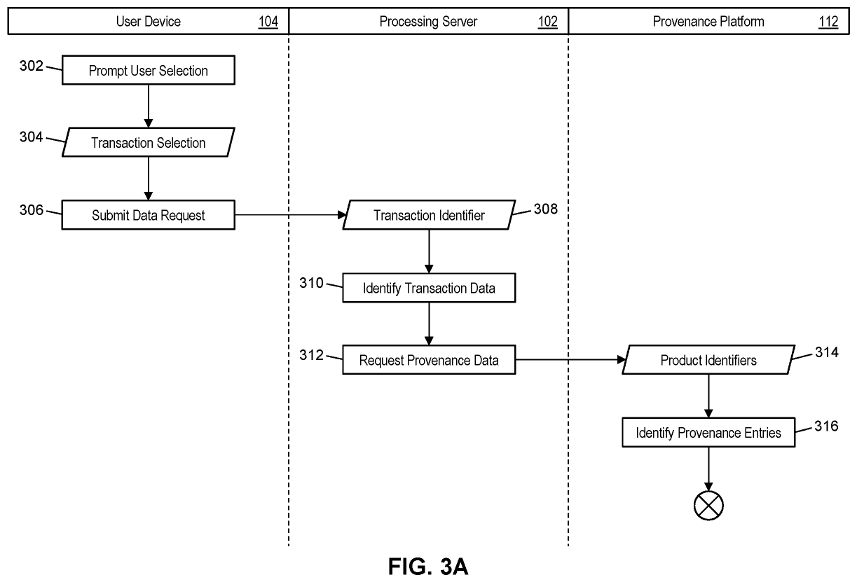

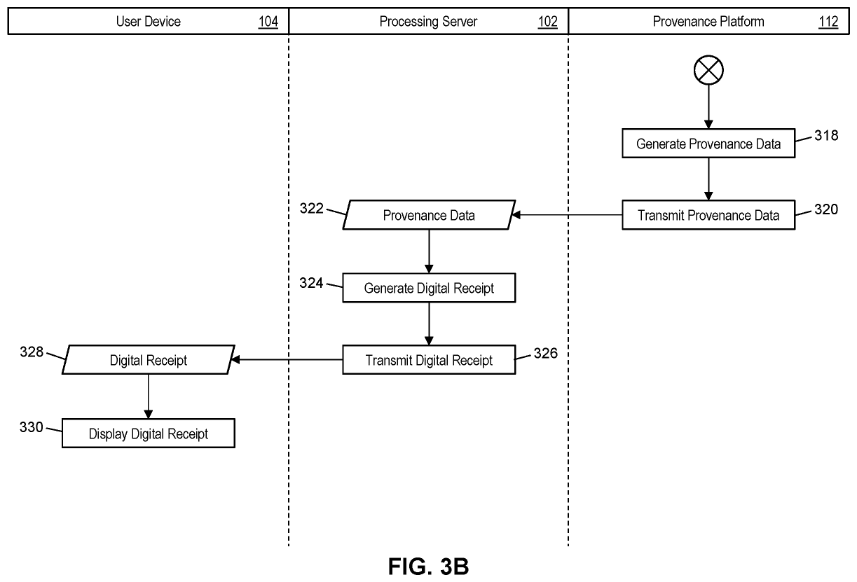

FIGS. 3A and 3B illustrate a process for generating a digital receipt for a payment transaction that includes provenance information for one or more products purchased in the transaction.

In step 302, the user device 104 can prompt a user thereof to select a payment transaction from a list of processed payment transactions involving the user as a payer. The list of payment transactions can display any data associated with the payment transaction that can assist the user in making a selection, such as a merchant name, transaction amount, transaction time and/or date, list of purchased product names, etc. In step 304, the user device 104 can receive a selection from the user of a processed payment transaction for which a digital receipt is requested. The selection can include the transaction identifier for the selected payment transaction. In some embodiments, the user can also select one or more products purchased in the payment transaction for which provenance data is requested, and can further select preferences regarding the provenance data, such as a level of detail, which types of provenance events are desired, etc. In step 306, the user device 104 can electronically transmit the transaction identifier, and any other information captured from the user, to the processing server 102 using a suitable communication network and method.

In step 308, the receiving device 202 of the processing server 102 can receive the transaction identifier and any other accompanying data from the user device 104. In step 310, the querying module 216 of the processing server 102 can execute a query on the account database 206 or memory 214 of the processing server 102 to identify additional transaction details for the payment transaction using the transaction identifier. Additional transaction details can include at least a product identifier for each product purchased in the payment transaction, and can further include a transaction time, transaction date, merchant identifier, merchant name, geographic location, transaction type, currency type, transaction amount, etc. In step 312, the transmitting device 222 of the processing server 102 can electronically transmit a request for provenance data to the provenance platform 112 using a suitable communication network and method. The request can include at least the product identifier for each product purchased in the payment transaction, or, in cases where the user of the user device 104 selected products manually, the product identifier for each product selected by the user (e.g., received by the processing server 102 in step 308).

In step 314, the provenance platform 112 can receive the product identifiers from the processing server 102. In step 316, the provenance platform can identify one or more blockchain data entries for each purchased product in the blockchain associated with the blockchain network 108 by identifying each blockchain data entry that includes a product identifier received in the request for provenance data. In step 318, the provenance platform 112 can generate a set of provenance data for each of the products. The provenance data can be generated following analysis of each blockchain data entry identified for each respective product and the provenance events detailed therein. In some cases, analysis of a provenance event can include identifying information regarding an associated entity, such as a merchant or manufacturer, where such information can include, for example, a name, trade name, geographic location, etc. The sets of provenance data can be formatted in a manner that maximizes readability for the user of the user device 104, such as requiring specific formatting of data included in the blockchain data entries and data identified on the basis thereof. In step 320, the provenance platform 112 can electronically transmit the generated sets of provenance data to the processing server 102.

In step 322, the receiving device 202 of the processing server 102 can receive the sets of provenance data from the provenance platform 112, where each set of provenance data can accompany a product identifier associated with the product to which the provenance data corresponds. In step 324, the generation module 218 of the processing server 102 can generate a digital receipt for the selected payment transaction. The digital receipt can be a data object that includes the sets of provenance data for each product (e.g., or selected product) purchased in the payment transaction as well as any additional transaction details identified by the processing server 102. In some embodiments, the data object can be formatted as an image or other suitable data type that is formatted in a manner similar to a traditional, physical receipt. In step 326, the transmitting device 222 of the processing server 102 can electronically transmit the digital receipt including the sets of provenance data for each product to the user device 104. In step 328, the user device 104 can receive the digital receipt and, in step 330, the user device 104 can display the digital receipt to a user thereof. The user can then be able to review the receipt for the transaction including provenance data for each product purchased in the payment transaction.

### Exemplary Method for Generating a Digital Receipt

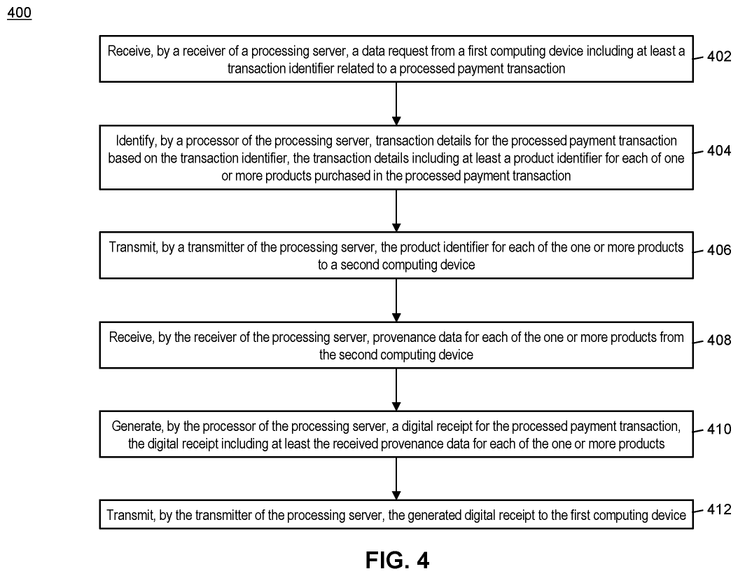

FIG. 4 illustrates a method 400 for generating a digital receipt for a transaction including provenance information for purchased products.

In step 402, a data request can be received by a receiver (e.g., receiving device 202) of a processing server (e.g., processing server 102) from a first computing device (e.g., user device 104), where the data request includes at least a transaction identifier related to a processed payment transaction. In step 404, transaction details for the processed payment transaction can be identified by a processor (e.g., querying module 216) of the processing server based on the transaction identifier, the transaction details including at least a product identifier for each of one or more products purchased in the processed payment transaction. In step 406, the product identifier for each of the one or more products can be transmitted by a transmitter (e.g., transmitting device 222) of the processing server to a second computing device (e.g., blockchain node 110, provenance platform 112, etc.)

In step 408, provenance data for each of the one or more products can be received by the receiver of the processing server from the second computing device. In step 410, a digital receipt for the processed payment transaction can be generated by the processor (e.g., generation module 218) of the processing server, the digital receipt including at least the received provenance data for each of the one or more products. In step 412, the generated digital receipt can be transmitted by the transmitter of the processing server to the first computing device.

In one embodiment, wherein second computing device can be a component of the processing server. In a further embodiment, each of the one or more data entries can further include at least one of: a timestamp, merchant data, shipping data, product data, and manufacturing data In another further embodiment, the method 400 can further include: identifying, by a processor (e.g., querying module 216) of the second computing device, one or more data entries for each of the one or more products that include the respective product identifier; and generating, by the processor (e.g., generation module 218) of the second computing device, the provenance data for each of the one or more products based on the identified one or more data entries for each respective product. In an even further embodiment, each of the one or more data entries can be a blockchain data entry included in a blockchain accessible by the second computing device. In a yet further embodiment, the second computing device can be a blockchain node (e.g., blockchain node 110) in a blockchain network (e.g., blockchain network 108) associated with the blockchain.

In some embodiments, the digital receipt can further include at least one of: time, date, geographic location, device identifier, point of sale identifier, transaction amount, transaction type, currency type, reward data, loyalty data, and offer data. In one embodiment, identifying transaction details for the processed payment transaction can include: transmitting, by the transmitter of the processing server, the transaction identifier to an external computing system; and receiving, by the receiver of the processing server, the product identifier for each of the one or more products from the external computing system.

### Computer System Architecture

FIG. 5 illustrates a computer system 500 in which embodiments of the present disclosure, or portions thereof, can be implemented as computer-readable code. For example, computing device 102 of FIGS. 1 and 2 and the user device 104, issuer system 106, blockchain node 110, and provenance platform 112 of FIG. 1 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for generating a digital receipt for a transaction including provenance information for purchased products. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for generating a digital receipt for a transaction including provenance information for purchased products, comprising:
receiving, by a receiver of a processing server, a data request from a first computing device including at least a transaction identifier related to a processed payment transaction;
identifying, by a processor of the processing server, transaction details for the processed payment transaction based on the transaction identifier, the transaction details including at least a product identifier for each of one or more products purchased in the processed payment transaction;
transmitting, by a transmitter of the processing server, the product identifier for each of the one or more products to a second computing device;
receiving, by the receiver of the processing server, provenance data for each of the one or more products from the second computing device;
generating, by the processor of the processing server, a digital receipt for the processed payment transaction, the digital receipt including at least the received provenance data for each of the one or more products; and
transmitting, by the transmitter of the processing server, the generated digital receipt to the first computing device.

2. The method of claim 1, wherein the second computing device is a component of the processing server.

3. The method of claim 2, further comprising:
identifying, by a processor of the second computing device, one or more data entries for each of the one or more products that include the respective product identifier; and
generating, by the processor of the second computing device, the provenance data for each of the one or more products based on the identified one or more data entries for each respective product.

4. The method of claim 3, wherein each of the one or more data entries is a blockchain data entry included in a blockchain accessible by the second computing device.

5. The method of claim 4, wherein the second computing device is a blockchain node in a blockchain network associated with the blockchain.

6. The method of claim 2, wherein each of the one or more data entries further includes at least one of: a timestamp, merchant data, shipping data, product data, and manufacturing data.

7. The method of claim 1, wherein the digital receipt further includes at least one of: time, date, geographic location, device identifier, point of sale identifier, transaction amount, transaction type, currency type, reward data, loyalty data, and offer data.

8. The method of claim 1, wherein identifying transaction details for the processed payment transaction includes:
transmitting, by the transmitter of the processing server, the transaction identifier to an external computing system; and
receiving, by the receiver of the processing server, the product identifier for each of the one or more products from the external computing system.

9. A system for generating a digital receipt for a transaction including provenance information for purchased products, comprising:
a first computing device;
a second computing device; and
a processing server including
a receiver receiving a data request from the first computing device including at least a transaction identifier related to a processed payment transaction,
a processor identifying transaction details for the processed payment transaction based on the transaction identifier, the transaction details including at least a product identifier for each of one or more products purchased in the processed payment transaction, and
a transmitter transmitting the product identifier for each of the one or more products to a second computing device, wherein
the receiver of the processing server further receives provenance data for each of the one or more products from the second computing device,
the processor of the processing server further generates a digital receipt for the processed payment transaction, the digital receipt including at least the received provenance data for each of the one or more products, and
the transmitter of the processing server further transmits the generated digital receipt to the first computing device.

10. The system of claim 9, wherein the second computing device is a component of the processing server.

11. The system of claim 10, wherein the second computing device includes a processor
Identifying one or more data entries for each of the one or more products that include the respective product identifier, and
generating the provenance data for each of the one or more products based on the identified one or more data entries for each respective product.

12. The system of claim 11, wherein each of the one or more data entries is a blockchain data entry included in a blockchain accessible by the second computing device.

13. The system of claim 12, wherein the second computing device is a blockchain node in a blockchain network associated with the blockchain.

14. The system of claim 10, wherein each of the one or more data entries further includes at least one of: a timestamp, merchant data, shipping data, product data, and manufacturing data.

15. The system of claim 9, wherein the digital receipt further includes at least one of: time, date, geographic location, device identifier, point of sale identifier, transaction amount, transaction type, currency type, reward data, loyalty data, and offer data.

16. The system of claim 9, wherein identifying transaction details for the processed payment transaction includes:
transmitting, by the transmitter of the processing server, the transaction identifier to an external computing system; and
receiving, by the receiver of the processing server, the product identifier for each of the one or more products from the external computing system.
